(19) United States
(12) Patent Application Publication
(10) Pub. No.: US 2004/0044677 A1
(43) Pub. Date: Mar. 4, 2004

(54) Method for personalizing information and services from various media sources

(75) Inventors: Sharon Huper-Graff, Tel-Aviv (IL); Shay Sarid, Givat Hen (IL); Slavik Markovitch, Kiryar Haim (IL); Paul Feigen, Haifa (IL); Joseph Tal, Elkana (IL); Sharon Biran, Beit Herut (IL)

Correspondence Address: SHAHAN ISLAM, ESQ., KMZ ROSENMAN, 575 Madison Avenue, New York, NY, 10022-2585, US

(73) Assignee: Better T.V. Technologies Ltd., Ramat-Gan (IL)

(21) Appl. No.: 10/233,971

(22) Filed: Sep. 3, 2002

(51) Int. Cl. G06F 7/00

(52) U.S. Cl. 707/102

(57) ABSTRACT

The present invention provide a method of conveying and classifying content and services of all kind of data sources over a global media information network system to provide end user with most relevant data content and services available fitting his preferences, habits and taste. It is thus another object of the invention to provide the media suppliers with method and system for personalizing and managing their information and services to achieve efficient transformation and regulation of content to their clients.

The end-users are provided with personalized recommendations lists of content and services selections from various media sources based on history log of user selections and activities. Users behavior is assessed and analyzed in relation to the selected content or services and updated in a personal profile. The selection of Recommendation List from available content and services is based on user personal created profile.

### BACKGROUND OF THE INVENTION

The present invention relates to the field of electronic information and media systems and, in particular, to a method and a system for automatically determining and dynamically configuring customized and personalized recommendation content lists according to user preferences, habits and taste in a global information super highway network.

Numerous advances have been made in recent years in the field of media information systems. For example, programming guides are now prevalent on many cable systems throughout the country. In one embodiment, these programming guides are offered on a particular channel within the broadcast service, and provide programming information for the next several hours. More advanced ones of these prior art systems may allow the user to interact with the program guide to manually select a particular program to record or view, alternatively the user can determine his preferences and receive customized program selection accordingly. Another example are the Personal Video Recorders (PVR), where user can record shows and watch them on his free time. Some of these PVR's also follow user behavior and use prior behavior to record what seem to be most relevant shows for the user.

The so-called “Information Super Highway” is expected to bring wondrous technological changes to society. Data of all kinds will become readily available to the public in quantities never before imaginable. Recent breakthroughs in digital broadcasting and video compression technologies are expected to extend the “Information Super Highway” right into the video realm by allowing customers to receive literally hundreds of TV and video channels in their homes. While the prospects of opening a whole new world of information to the average person are exciting, there is much concern that the average person will simply be overwhelmed by the quantity of data delivered into their homes. The super highway includes not only video and audio sources but also the world wide web source including all kind of materials: text, multimedia, animation etc. More over this new media enables interactive interface with the user creating a new platform for interactive activities, e.g. e-commerce, interactive multimedia shows, chatting and messaging activities games etc.

Some techniques must be developed which permit the travelers of the Information Super Highway to navigate through the plethora of available information sources without getting hopelessly lost.

That is to say, none of these prior art information service and entertainment systems are capable of automatically dynamically configuring the entertainment system and information services in accordance with a user profile corresponding to the user viewing habits, and past behavior.

It is a problem in the field of electronic media information networks system to enable a user to access information, services and applications of relevance and interest to the user without requiring the user to expend an excessive amount of time and energy searching for the information.

Another major issue immerging in the new information age, is the technical limitations of the communication system such as law bandwidth capacity and constrained communication devices e.g., cellular phones. Hence, the necessity for filtering and personalizing the available content and services is of great importance for both clients and providers.

Whatever solution is chosen, it would be highly advantageous to have a computer tool that enables to classify all information sources (content and services alike) and present the user with a personalize data content recommendation.

It is thus the prime object of the invention to avoid the limitations of the prior art and to provide a system, and method of conveying and classifying all kind of data sources over a global media information network system to provide the user with most relevant data content and services available fitting his preferences, habits and taste It is thus another object of the invention to provide the media suppliers with method and system for personalizing and managing their information and services to achieve efficient transformation and regulation of content to their clients, thus supporting the rapidly changing environment of technology improvements.

### SUMMARY OF THE INVENTION

A method for creating personalized recommendations lists out of available content and services selections from various media sources based on history log of user selections and activities (“User Behavior”) comprising the steps of: Receiving from the media sources providers content and services Attributes containing technical details and abstract evaluations of the content and services; standardizing the available content and services Attributes; assessing user behaviors (Behavior Evaluations) relating to the selected content or services and recording thereof in the user history log; updating/initializing a first profile (“Behavioral Profile”) of user where the profile evaluations (PDP parameters values) are based upon analyzing the user history log; evaluating (PDP Evaluation) the available content and services as function of their relevance to the Behavioral Profile by comparing the Content and Services Attributes to relevant PDP parameters; scoring (“Scoring Rate”) the available Content and services as a combination of the said PDP Evaluation; and conducting a first selection (“Recommendation List”) of available content and services according to said Scoring Rate;

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is a general diagrammatic representation of the environment in which the present invention is practiced;

FIG. 2 is a block diagram of the recommendation and learning system according to the present invention;

FIG. 3 is a diagram illustrating available classification of information and service sources profiles;

FIG. 4 is flow-chart illustrating the process the BRS system

FIG. 5 is flow-chart illustrating the process the DRS system

FIG. 6 is a flow-chart of tracking and analyzing viewer history log;

FIG. 7 is a flow-chart illustrating the process of updating user profiles according to history log;

### DETAILED DESCRIPTION OF THE PREFERRED EMBODIMENTS

The embodiments of the invention described herein are implemented as logical operations in a communication network system. The logical operations of the present invention are implemented (1) as a sequence of computer implemented steps running on the communication network system and (2) as interconnected machine modules within a computing application. The implementation is a matter of choice dependent on the performance requirements of the communication network systems implementing the invention. Accordingly, the logical operations making up the embodiments of the invention described herein are referred to variously as operations, steps, or modules.

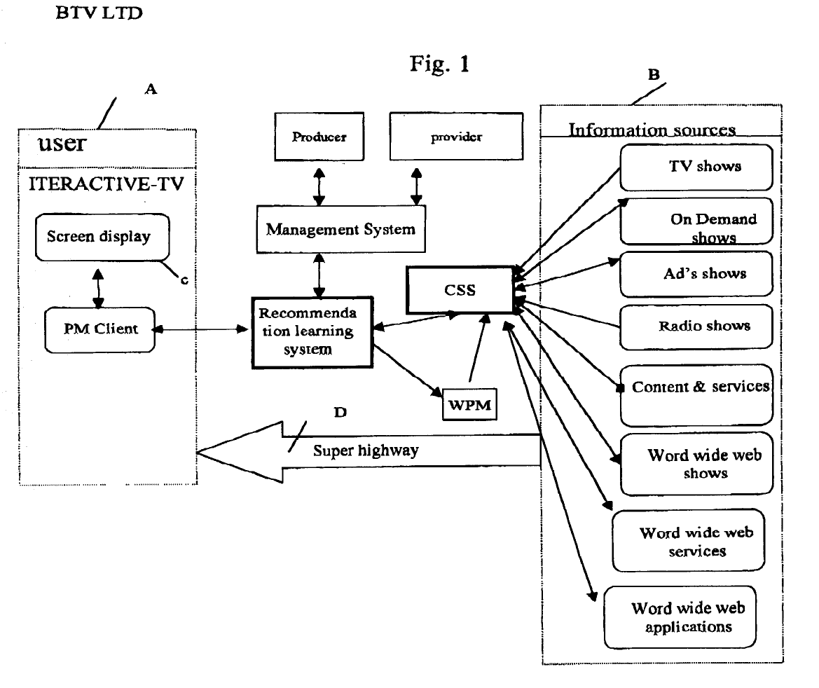

FIG. 1 illustrates the operating environment in which the present invention is used. As seen in FIG. 1 the user A is connected to global information sources B using an Interactive communication device C such as TV, cellular phones, a computer devices, via central media super highway D. The provider enables the user to select from the available content and services as offered by the various information sources.

For purposes of this disclosure, by the term “content” is meant for such content as passive and interactive TV or radio programs, VOD and NVOD services, multimedia applications, electronic messages data, web sites content etc.

For purposes of this disclosure, by the term “services” is meant for such utilities as commercial transaction or interactive services or message management service e.g. SMS etc.

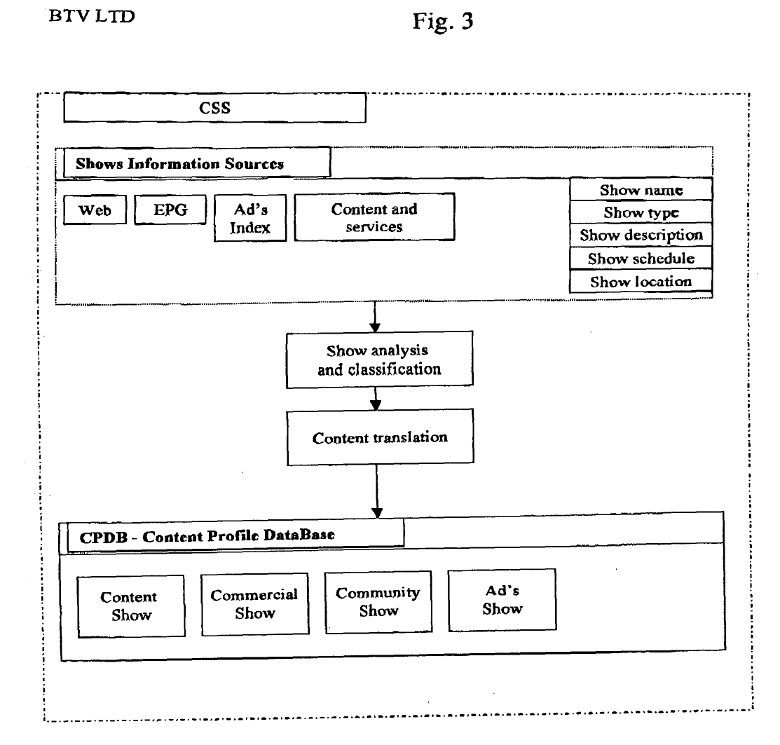

The available content and services are indexed and classified within Categorization and Scoring System (CSS), as exemplified in FIG. 3. There are different classification categories in reference to the respective source media. Relevant details such as time schedule, short descriptions and content or services attributes e.g. style, type rating etc., are provided along with the content and services. The content items are further analyzed according to their content, to create additional content attributes and classify thereof to fit the different aspects of the user activities, as exemplified in FIG. 3

The history information of user viewing habits are further stored in a central database—World Wise Guide—WWG. (FIG. 1) According to prior art the user is exposed to all available information sources, he can select any content or services according to time schedule and navigate through the network by computerized catalogs (directories) and search engines.

It is suggested according to the present invention to provide the user with a designated learning system for creating a dynamic personalized recommendation list of available content or services. Such learning system can be implemented as central service application located at gateway servers or partly as add-ons application (WG user interaction model) at the user communication device, or any combination these implementations.

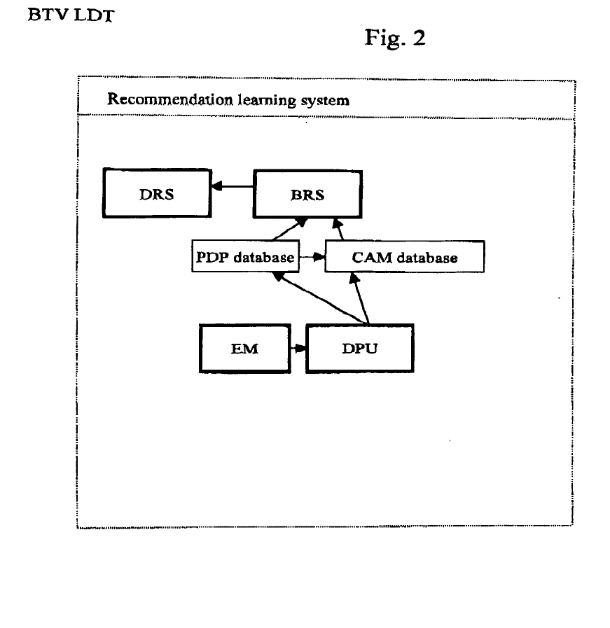

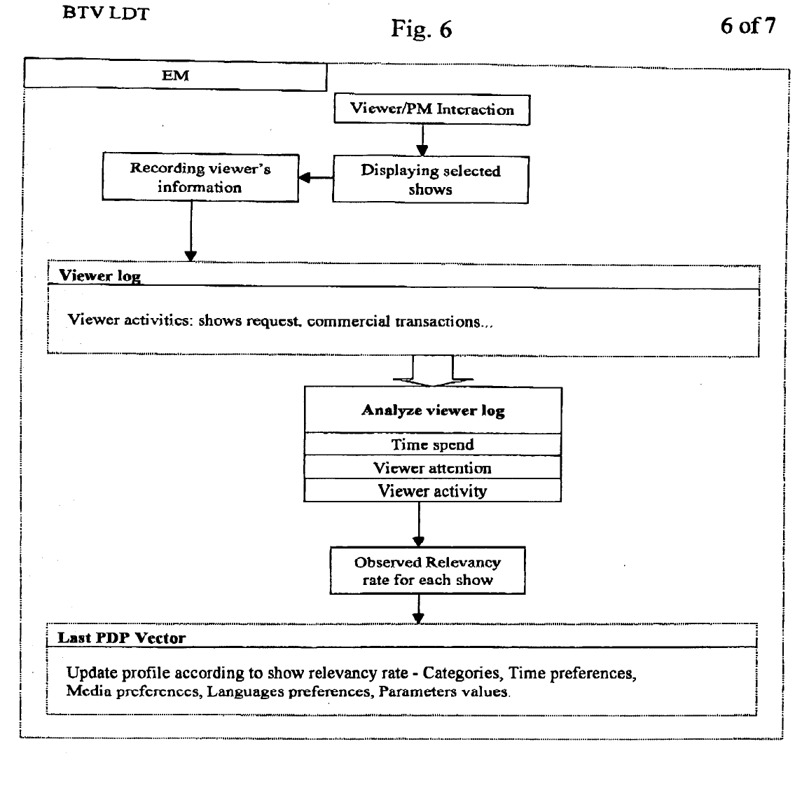

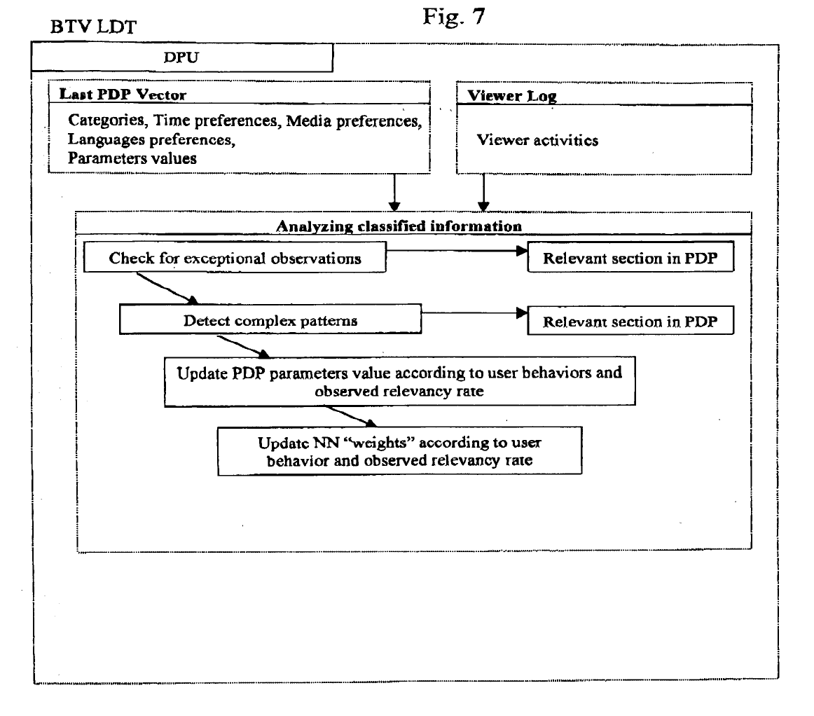

The main components of the learning system are illustrated the in FIG. 2: the Dynamic Recommendations System (DRS) for online updating of pre-personalized recommended selections of content and services created by the BRS application and based upon the PDP (Personal Dynamic profile) database which contains the user behavioral profiles and CDP (Community Dynamic Profile) database containing community profiles both updated by the DPU (Dynamic Profile Update, see FIG. 7) application, according to the history collected and analyzed by the EM (Evaluation Module, See FIG. 6) application.

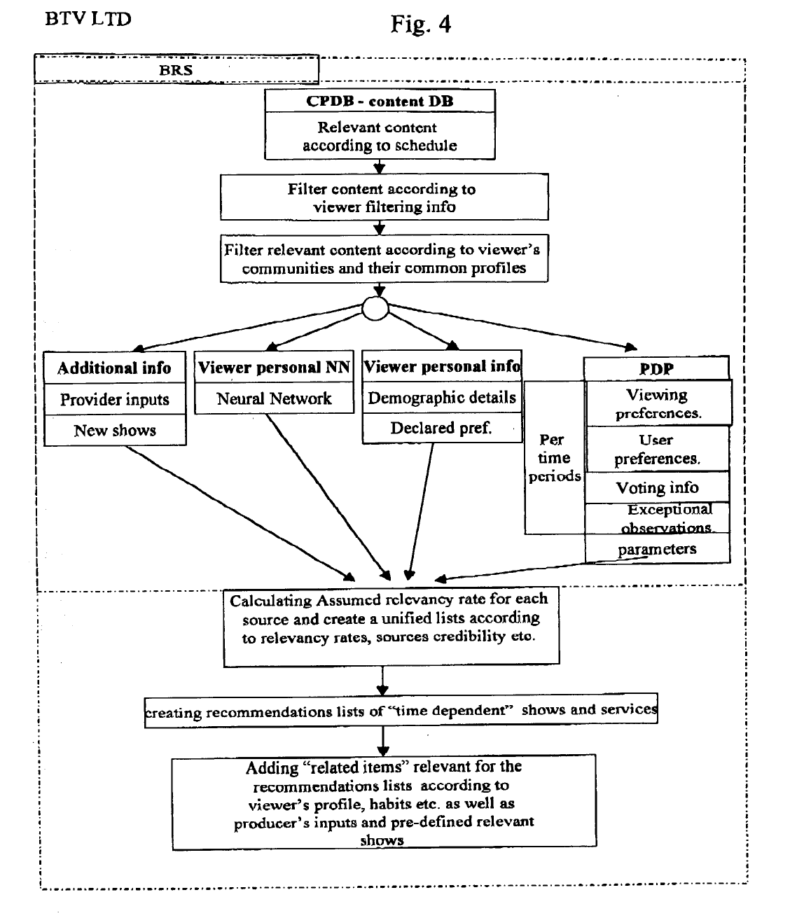

The process flow chart of BRS system is illustrated in FIG. 4, all available information of the content and services is supplied from the CSS system, this information is classified and filtered in several stages as follows: First all content and services inherently defined by the user as unwanted are excluded from the available selection.

Secondly the shows and services are categorized according to community profile as explained herein:

Each user is classified into different community categories according to the reported personal details and his history activities. For example the user community categorization can be defined according to his mother tongue and dedicated passion for watching nature films. According to the user community categories the available selections of shows and services will be respectively chosen (“Proposed Selections”).

Then all available content and services are processed by a dynamic set of filtering/matching systems, based upon user history and PDP (Personal Dynamic Profile), provider inputs, the history of the entire users community etc.

The PDP System creates and updates behavioral profiles (PDP vectors) of the users. Each PDP vector contains parameters representing user preferences according to time schedule, content and services types, and pre-defined categories indicating the user favorite subjects of interest or user attitude to different styles e.g. action movies. The parameters values represent the strength of each preference with regard to specific category. The values are updated as function of the user actual activities. Each of the incoming content and services is scored according to the PDP vectors parameters values, where each of the PDP parameters is matched with the relevant attributes of the content or services. For example let us assume that the user profiles indicate his desire to watch comedy shows, as a result the relevant shows defined by the content attributes as comedy are scored accordingly. The evaluating process further enables to coordinate between plurality of the content and services attributes and PDP parameters, as a result the content and services evaluating mechanism can reflect complex relations of the user preferences. For example, if the user prefers to watch action movies in the afternoon and romantic one in the evenings the content or services are evaluated respectively. The relations between the parameters are not limited to time schedules but can refer to any possible combination of the said attributes.

The system uses diverse approaches for user profiling and personalization. Another type of PDP representation and matching technique is based upon the principles of Neural Networks (NN), which are explained herein (reference U.S. Pat. No. 5,050,095).

Neural Networks, generate rules of association as result of a learning process analysis based on the networks exposure to either supervised or unsupervised input data samples drawn from a given “statistical universe”.

These NN systems have, to various degrees, some ability to make generalizations about that statistical universe as a whole, based on the input data sampling.

Neural Networks are comprised of associative memory components building organized structure, (architectures), of processing elements. Individually, these elements are each analogous to an individual neuron in a biological system. Individual processing elements have a plurality of inputs, which are functionally analogous to the dendrite processes of a neuron cell. As such, these elements are conditioned in accordance with a paradigm over the course of an ongoing learning process, to dynamically assign and assert a certain “weight”, based on the current state of the systems knowledge, to the respective inputs. The associative “weights” data are stored in the associative memory components of the system. Digital computer implementations of neural networks (“Digitizes Neural Networks”) typically employ numerical methodologies to realize and yield the desired associative recall of stimulus-appropriate responses through weighted summation of the inputs in a digital computing environment.

Implementing NN system where the input data of user activities history functions as the data samples of the “Statistical Universe”, will create an associative data memory structure where the “weight” data represent the user preferences and behavioral characteristic relating the various content and services. This associative data memory structure is used to perform smart evaluating regarding the incoming content or services, where the evaluating of each content or service is determined by employing Numerical Methodologies of the digitized NN system according to the relevant memory data “weights”.

In one aspect this learning and evaluating process functions partly as substitute for the human manual selection process, sparing the user the tedious process of exploring all available content and services and picking up the most relevant and favorite contents/services. Further more this system can detect and identify complex behavior patterns which the user himself is not aware of. For example the user habits of reading the news while listing to certain type of music or ordering fast-food when watching a specific type of TV shows.

The evaluating of content and services by the different matching systems are merged to create united scoring scale. The merging process ranks the evaluations of each designated system in accordance with the relative success of each system to predict the user behavior. The ability to predict user behavior is measured by checking the correlation between the evaluations of each content or services and the user actual behavior relating to the respective content or services.

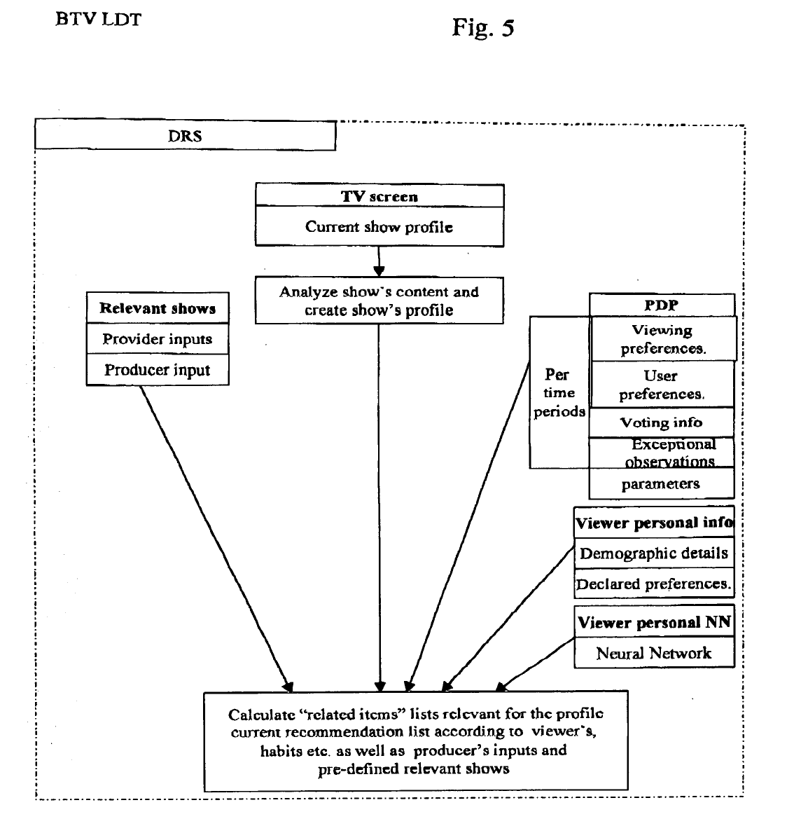

Once the user is activating the Interactive communication device he is prompted with relevant recommendation lists personalized according to the pre-defined aspects of user activities, for example: content media like TV shows, video films, interactive multimedia application etc. Commercial activities like sales, community activities like Internet forums, advertisements and chatting activities through the Internet or cellular network. While the user selects from the available recommendation lists as created by the BRS system or alternatively from new relevant shows or services, the DRS online system is tracking in real-time user current activities as illustrated in FIG. 5. The DRS system is operating according to the same principles of the BRS system as described above. The DRS system applies the BRS method for classifying and scoring the current content and services with regard to up-to-date profile of the user as represented by his current choices.

FIG. 6 is demonstrating the process of tracking the user activities while using the Interactive communication device and storing thereof in the viewer history log. The history log contains all recorded user selections and activities while watching and communicating via the Interactive device. Such activities include viewing TV shows, listening to radio programs, navigating web-pages through the Internet or cellular network, conducting commercial transactions etc. The history log is analyzed and organized in order to determine the user behavioral profile. This profile is based among other attributes (as described above) upon the following measured parameters: the total viewing time for each content or service, the viewer attention, viewer decisions and all interactive action preformed by the user e.g. conducting search through the internet, rating the current show etc. The history log is compared with the expected activity behavior as predicted by the BRS.

In result of the above analysis of the history log, the last PDP is updated accordingly as illustrated in the process of FIG. 7.

In the first stage of the process exceptional observations of the user behavior are detected, the user behavior is assessed in comparison to “normal” behavior of the user himself or the behavior of his related communities. When comparing the user new activities to his past behavior, the behavior is analyzed to detect changes of styles or subjects of interests, according to the measured parameters and statistical calculations. For example if the user usually watches dramatic movies and suddenly starts viewing comedies, there are several alternatives, first the user changed his style, second it was one occasional incident, third we have tracked a new pattern of the user activity. The first two options can be easily detected according to the time and attention dedicated for the measured behavior, its rating etc.

Analyzing new behavior patterns is more complicated and can be achieved by testing relations of any possible combination of the user different activities and calculating their relevant correlation. For example, in case the system detects frequent successive activities like engaging in a chat during certain TV show, this behavior pattern is recorded in the respective PDP parameters. Thus next time the user performs an anterior activity the successive activity will be evaluated accordingly. The recognized pattern is not limited to schedule relations or direct association between two activities.

According to the above analyzing process the designated systems are updated as follows:

The PDP vectors of the PDP system are updated respectively, each parameter value of the vector is changed in accordance with the user history activities. For example, in case the user is frequently viewing comedies as detected in the user history log, the respective parameter value is changed to higher value reflecting proportional user preference regarding comedies show style. In case of detecting correlation between activities the respective parameters are updated reflecting the strength of relations between different shows and services.

The NN system weights representing the strength of the user preferences and correlation between user different activities are updated to reflect the actual behavior of the user according to the methodology of the Digitized NN system as described above.

The process of the present invention provides efficient utilities for the benefit of the interactive communication device users, as described above the users are presented with pre-selected information of the most relevant content and services. The information stored and arranged according to present invention can be great value to the provider and producers for more efficient data management.

The ability to personalize the relevant content and services for each user can also be beneficial for commercial corporations.

Finally, it should be appreciated that the above-described embodiments are equally applicable to computerized network communication in general, such as TV cable, broadband services, cellular, satellite etc.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A method for creating personalized recommendations lists out of available content and services selections from various media sources based on history log of user selections and activities (“User Behavior”) comprising the steps of:
Receiving from the media sources providers content and services Attributes containing technical details and abstract evaluations of the content and services;
Standardizing the available content and services Attributes;
Assessing user behaviors (Behavior Evaluations) relating to the selected content or services and recording thereof in the user history log;
Updating/initializing a first profile (“Behavioral Profile”) of user where the profile evaluations (PDP parameters values) are based upon analyzing the user history log;
Evaluating (PDP Evaluation) the available content and services as function of their relevance to the Behavioral Profile by comparing the Content and Services Attributes to relevant PDP parameters;
Scoring (“Scoring Rate”) the available Content and services as a combination of the said PDP Evaluation; and
Conducting a first selection (“Recommendation List”) of available content and services according to said Scoring Rate;

2. The method of claim 1 wherein the available content are passive multimedia presentations e.g. TV or radio programs;

3. The method of claim 1 wherein the available content are interactive multimedia applications e.g. interactive TV programs, games etc.

4. The method of claim 1 wherein the available services comprise one way activities operating in information networks e.g. searching database through the Internet.

5. The method of claim 1 wherein the available services comprise interactive activities through communication networks e.g. commercial activities or content consuming via internet;

6. The method of claim 1 wherein the available services comprise interactive activities through wireless communication networks e.g. chatting activities via cellular network;

7. The method of claim 1 wherein the process of analyzing the history log comprising the steps of:
Detecting user New Behavior compared with previous history log;
Detecting user frequent selections and activities (“User Habits”);
Detecting correlation (Behavior Pattern) between user behaviors relating attributes of the relevant content;

8. The method of claim 6 wherein the process of updating the behavioral profile comprise the steps of:
Changing the values of the respective PDP vector parameters according to user NEW behavior;
Changing the values of the respective PDP vector parameters according to User Habits;
Changing the values of the respective PDP vector parameters according to Behavior Pattern;

9. The method of claim 1 further comprising the steps of:
Creating Data Samples of User Behavior based upon the history log;
Updating/initializing the Weights values of a Digitized Neural Network (“Digitized NN”) in accordance with an ongoing learning process (“Paradigm”) based upon the said Data Samples;
Evaluating (NN Evaluation) the available Content by employing Numerical Methodologies of the Digitized Neural Network based upon the said Weights updated values;
Merging the NN Evaluations with PDP evaluations to create one Scoring Rate of all content and services;

10. The method of claim 9 wherein the merge process comprise the steps of:
Measuring correlation (“PDP Relevance”) between previous PDP evaluations and past user behavior relating to the respective content and services;
Measuring correlation (“NN Relevance”) between previous NN evaluations and past user behavior relating to the respective content and services;
Rating (“Scoring Rate”) the NN evaluations and PDP evaluations according to their measured Relevance;

11. The method of claim 1 further comprising the steps of:
Receiving from a user a declared profile (“Personal profile”) containing demographic details and declared preferences;
Conducting a second selection (“Proposed Content and Services”) of available content and services according to the user declared preferences as defined in the Personal Profile;

12. The method of claim 11 wherein the user declared preferences comprises evaluations of user attitude to various subjects.

13. The method of claim 11 further comprising the steps of:
Creating a third profile (“Community Profile”) of users where the profile features evaluations are based upon matching the user history log and Personal Profile to relevant history logs and personal profile of other users;
Evaluating (“Community Evaluations) the Proposed Content according to the community profile;
Merging the Community Evaluations with PDP evaluations to create one Scoring Rate of all content and services. The method of claim 13 wherein the merge process comprise the steps of:
Measuring correlation (“PDP Relevance”) between previous PDP evaluations and past user behavior relating to the respective content and services;
Measuring correlation (“Community Relevance”) between previous Community relevance evaluations and past User Behavior relating to the respective content and services;
Rating (“Scoring Rate”) the NN evaluations and PDP evaluations according to their measured Relevance;

14. The method of claim 1 further comprising the step of creating additional content and services Attributes based upon new classifications
